(19) United States
(12) Patent Application Publication
(10) Pub. No.: US 2019/0392209 A1
(43) Pub. Date: Dec. 26, 2019

(54) Document Analyzer, Document Analysis Method, and Computer-Readable Storage Medium Storing Program

(71) Applicant: KONICA MINOLTA, INC., Tokyo (JP)

(72) Inventor: Koichi Tashiro, Tokyo (JP)

(73) Assignee: KONICA MINOLTA, INC., Tokyo (JP)

(21) Appl. No.: 16/441,332

(22) Filed: Jun. 14, 2019

(30) Foreign Application Priority Data
Jun. 22, 2018 (JP) 2018-118411

(51) Int. Cl. G06K 9/00; G06F 17/27

(52) U.S. Cl. CPC G06K 9/00463; G06F 17/2765; G06F 17/2705

(57) ABSTRACT

The document analyzer includes a hardware processor. The hardware processor analyzes a construction of a passage with multiple techniques, thereby obtaining multiple analysis results. For each of unit segments related to the construction of the passage, the hardware processor identifies segment areas with the respective techniques based on the analysis results. For each of the unit segments, the hardware processor selects a segment area based on the analysis results from the segment areas identified with the respective techniques.

### BACKGROUND

### 1. Technological Field

The present disclosure relates to a document analyzer, a document analysis method, and a computer-readable storage medium storing a program(s).

### 2. Description of the Related Art

These is a technology for displaying or variously processing document data by parsing (e.g. JP 2010-282347 A). There is also a technology for extracting sentences suitable for a summary from document data by performing lexical analysis on the document data (e.g. JP 2017-10107 A).

Relatively long documents, technical documents and business documents in particular, tend to be constructed of the body divided into chapters, sections, subsections, and/or the like, but there are still many unstructured documents, in which document data is not clearly defined as structured documents. There is known a technology for convening such unstructured documents into structured documents by analyzing the unstructured documents (e.g. JP 2016-6661 A). There is also a technology for creating document having a table of contents by analyzing scanned document image data (e.g. U.S. Pat. No. 9,454,696 B2).

However, how breaks are set in a passage differs from document to document. Furthermore, in an unofficial document or the like, breaks are often not set in a consistent manner. If a certain (single) technique is used to determine the whole construction of such a documents with a rigidly uniform reference (standard), the construction is unlikely to be obtained with accuracy.

### SUMMARY

Objects of the present disclosure include providing a document analyzer, a document analysis method, and a computer-readable storage medium storing a program(s) that can more properly determine the construction of a passage.

In order to achieve at least one of the abovementioned objects, according to a first aspect of the present disclosure, there is provided a document analyzer including a hardware processor that: analyzes a construction of a passage with multiple techniques, thereby obtaining multiple analysis results; for each of unit segments related to the construction of the passage, identifies segment areas with the respective techniques based on the analysis results; and for each of the unit segments, selects a segment area based on the analysis results from the segment areas identified with the respective techniques.

According to a second aspect of the present disclosure, there is provided a document analysis method including: analyzing a construction of a passage with multiple techniques, thereby obtaining multiple analysis results; for each of unit segments related to the construction of the passage, identifying segment areas with the respective techniques based on the analysis results; and for each of the unit segments, selecting a segment area based on the analysis results from the segment areas identified with the respective techniques.

According to a third aspect of the present disclosure, there is provided a non-transitory computer-readable storage medium storing a program to cause a computer to: analyze a construction of a passage with multiple techniques, thereby obtaining multiple analysis result; for each of unit segments related to the construction of the passage, identify segment areas with the respective techniques based on the analysis results; and for each of the unit segments, select a segment area based on the analysis results from the segment areas identified with the respective techniques.

### BRIEF DESCRIPTION OF THE DRAWINGS

The advantages and features provided by one or more embodiments of the present invention will become more fully understood from the detailed description given hereinbelow and the appended drawings which are given by way of illustration only, and thus are not intended as a definition of the limits of the present invention, wherein:

FIG. 1 is a schematic view showing overall configuration of a passage construction analysis system according to a first embodiment;

FIG. 2 is a block diagram showing functional configuration of a processing apparatus;

FIG. 3A shows an example of contents of passage to be analyzed;

FIG. 3B shows the example of contents of a passage to be analyzed;

FIG. 4 shows an example of logical segments (chapters, sections, or subsections) of a passage identified with analysis techniques and confidence degrees of the segments;

FIG. 5 shows on example of logical segments identified with the analysis techniques and confidence degrees of the segments in a part following the first segment of the passage;

FIG. 6 is a flowchart showing a control procedure by a controller in a construction analysis process;

FIG. 7A is a flowchart showing a control procedure in a tag analysis process called in the construction analysis process;

FIG. 7B is a flowchart showing a control procedure in a text analysis process called in the construction analysis process;

FIG. 8 is a flowchart showing a control procedure in an image analysis process called in the construction analysis process;

FIG. 9 is a flowchart showing a control procedure in a segment selection process called in the construction analysis process;

FIG. 10 shows a modification of an object to which the confidence degree(s) is set;

FIG. 11 is a flowchart showing a modification of the segment selection process;

FIG. 12. shows an example of a case where the number of identified segments differs from analysis technique to analysis technique;

FIG. 13 is a flowchart showing a modification of the construction analysis process;

FIG. 14A is an illustration to explain the segment selection process according to the modification;

FIG. 14B is an illustration to explain the segment selection process according to the modification;

FIG. 15 is a flowchart showing the segment selection process according to the modification;

FIG. 16 is a schematic view showing overall configuration of a passage construction analysis system according to a second embodiment;

FIG. 17 is a block diagram showing functional configuration of a part of the passage construction analysis system according to the second embodiment, wherein the part performs the construction analysis process;

FIG. 18 is a flowchart showing a control procedure in the construction analysis process according to the second embodiment;

FIG. 19 is a block diagram showing functional configuration of a part of a passage construction analysis system according to a third embodiment, wherein the part performs the construction analysis process; and

FIG. 20 is a flowchart showing a control procedure in the construction analysis process according to the third embodiment.

### DETAILED DESCRIPTION OF EMBODIMENTS

Hereinafter, one or more embodiments of the present invention will be described with reference to the drawings. However, the scope of the present invention is not limited to the disclosed embodiments.

### [First Embodiment]

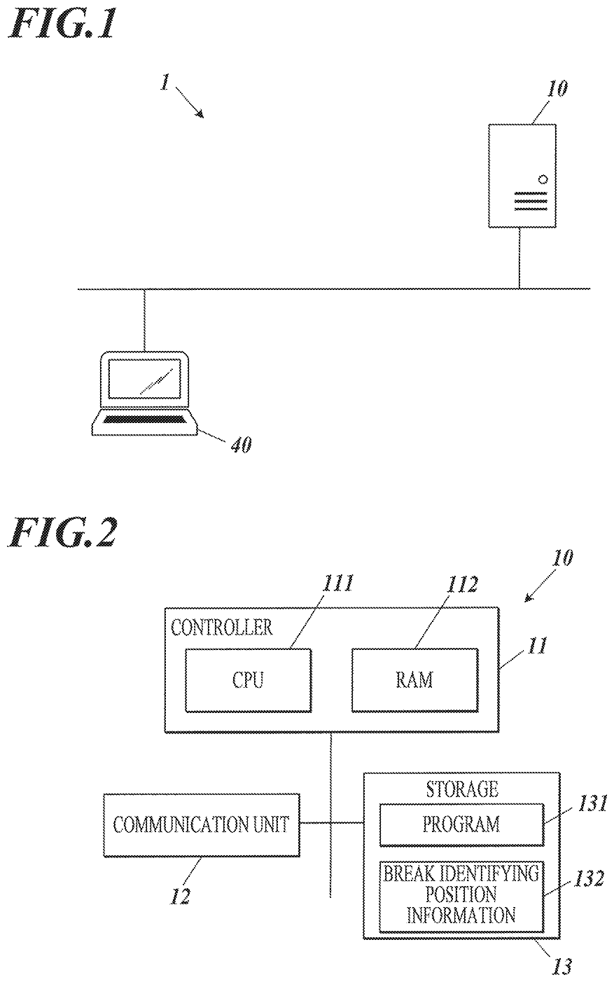

FIG. 1 is a schematic view showing overall configuration of a passage construction analysis system 1 according to a first embodiment.

The passage construction analysis system 1 includes a processing apparatus 10 (document analyzer) and a terminal apparatus 40. The processing apparatus 10 and the terminal apparatus 40 connect and communicate with one another by network wiring with LAN (Local Area Network) cables, a wireless LAN wirelessly, or USB cables one-to-one.

The terminal apparatus 40 is a personal computer (PC) or the like used by a user. The processing apparatus 10 is a computer that analyzes passage data sent from the terminal apparatus 40 together with a request for passage construction analysis (construction analysis request).

FIG. 2 is a block diagram showing functional configuration of the processing apparatus 10.

The processing apparatus 10 includes a controller 11, a communication unit 12, and a storage 13.

The controller 11 is a hardware processor including a CPU 111 (Central Processing Unit) and a RAM 112 (Random Access Memory). The CPU 111 performs various types of arithmetic processing. The RAM 112 provides a working memory space for the CPU 111 and temporarily stores data. The controller 11 controls operation of the processing apparatus 10 in whole. The controller 11 performs processes related to passage construction analysis.

The communication unit 12 connects to a network, and communicates with external apparatuses in accordance with a predetermined communication standard (protocol). The communication unit 12 includes a network card (LAN card), for example.

The storage 13 stores various programs 131 executed by the CPU 111, setting data, and so forth. The storage 13 includes any type of nonvolatile memory, such as a flash memory, and/or a hard disk drive (HDD). The programs 131 include a program(s) related to the passage construction analysis. The setting data includes break identifying position information 132. The break identifying position information 132 includes information on position(s) to be identified as breaks in a passage.

In addition to the abovementioned components, the processing apparatus 10 may include a display, an operation receiver, and so forth. The display may include any type of display, and the operation receiver may include a keyboard and a pointing device (e.g. mouse).

Next, the passage construction analysis by the processing apparatus 10 according to this embodiment will be described.

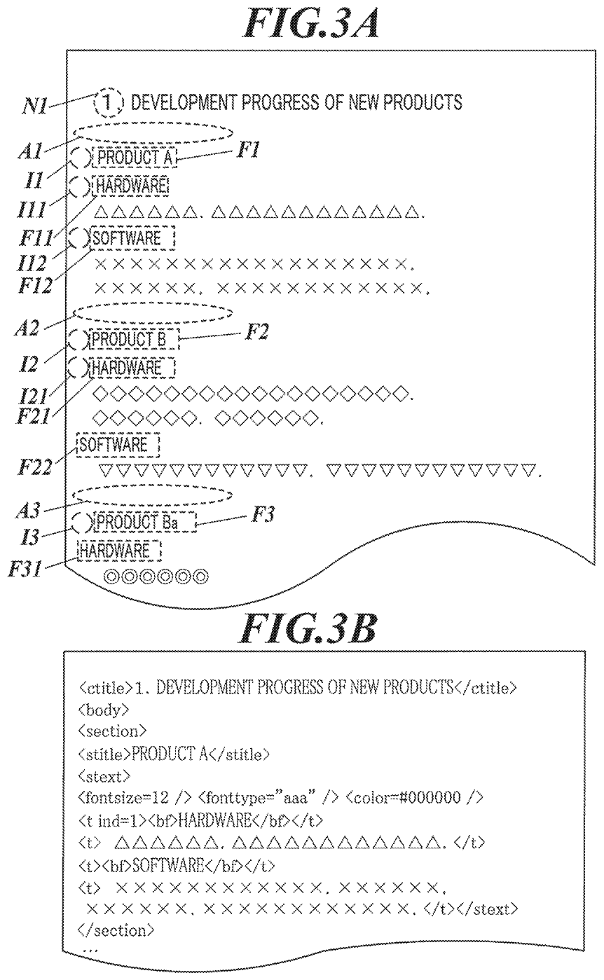

FIG. 3A and FIG. 3B show an example of contents of a passage of a document to be analyzed.

The document to be analyzed is generated, for example, of contents being divided into chapters, sections, subsections, and/or the like. In this embodiment, in the display state of the document, as shown in FIG. 3A, a chapter “Development Progress of New Products” is divided into sections of products, and each section of a product is divided into subsections of hardware and software.

Titles (headings) of the sections and the subsections are written in boldface type. Before (above) the respective sections, spaces are provided in a line direction. The titles are indented, but some of the titles (e.g. subsection titles indicated by F22 and F31) are not indented. An unofficial document arbitrarily created by the user with a text editor (text editing software) or the like tends to be not uniform in style/format.

The passage construction analysis system 1 of this embodiment analyzes such a document (passage), and on the basis of the analysis result, divides the document into structural units (unit segments) (i.e. determines areas of unit segments) in accordance with break positions defined by a setting. For example, on the basis of the setting to divide a document into sections with section titles as references, the passage construction analysis system 1 detects and evaluates styles and expressions that are likely to be titles and bodies, and identifies areas of segments (logical segments) (which hereinafter may be called “unit segment areas” or “segment areas”). The passage construction analysis system 1 uses multiple analysis techniques (three or more types if possible), and, for each segment, identifies segment areas with the respective analysis techniques, and selects, from the segment areas identified with the respective analysis techniques, the most appropriate segment area specified with one of the analysis techniques, the one being the most appropriate analysis technique for the segment.

As the multiple analysis techniques, well-known techniques are used. In this embodiment, structure analysis using tags or commands of a document such as a structured document described in a markup language (e.g. XML documents, OOXML documents, ODF documents, HTML documents, and source files of LaTex documents), text analysis (lexical analysis) using text contents of a document to extract title-like parts, and image analysis using display image data of a document are used. If the document to be analyzed is an unstructured document, structure analysis is omitted. If the document to be analyzed is a text document not having a page break setting (form feed setting) but having a setting to divide a document into pages, text analysis may be omitted. Also, if the document to be analyzed is a text document, image analysis is performed after the text document in the display state is converted into an image(s). If the document to be analyzed is a document image, text analysis is performed after its image data is converted into a text(s).

In a tag analysis process, descriptions in a markup language (tag elements) in a structured document are detected, and the construction of a passage (of the document) is analyzed. In the tag analysis process, for example, various tags are extracted, and from the extracted tags, tags commonly used for passage segmentation/division (range/area specifications of chapters, sections, and subsections, or breaks) and title display are retrieved.

The display image shown in FIG. 3A is, in structured document data, as shown in FIG. 3B, texts described by using various tags. In a structured document, information on contents is specified by mainly using tags in the format of “<tag name> contents </tag name>”. Examples of the tag name include: a tag element name indicating the type of contents exemplified by a document title, a chapter title, a section title, a body text, and a note (e.g. footnote); and a tag element name indicating the form exemplified by a font size, a font type, a display color, boldface, italic, and being underlined. They each include, as needed, an attribute name of the tag element and/or its attribute value (which is not limited to a numeral(s) but includes a symbol(s) and/or a letter(s)). Hence, if tags (a pair of tags) for a chapter title or a section title are detected, it may be determined that a text indicated by the tags is the head (first) text of the chapter or section (segment).

In the case shown in FIG. 3B, a tag <ctitle> for a chapter title and a tag <stitle> for a section title are examples of the above. Meanwhile, those not clearly specified as titles but described/specified in/by a bold font (e.g. a tag element indicated by <bf> and </bf>) independently in a text (e.g. a tag element indicated by <t> and </t>) can also be selected as titles, namely subsection headings in the case shown in FIG. 3B. In an XML document or the like, degree of freedom in setting tag element names is high. The tag element names and attribute names shown herein do not depend on a particular software program or the like. To detect tags properly, a detection standard (rules) should be determined to detect names that are likely to be titles, regardless of language, namely, no matter whether the language is, for example, English or Japanese.

Taking a case into account that a document is not perfectly accurately structured, a tag correspondence relationship and so forth may be not completely or strictly considered. In this case, in the tag analysis process, likelihood of a segment, which is between boundary positions of both ends, is quantitatively evaluated as a degree of certainty (hereinafter “confidence degree”) according to spaces at identified break positions (boundary positions), the number of characters (or words) of a selected title(s), a correspondence relationship between the selected title and other titles, and so forth. That is, in the tag analysis process, the confidence degree(s) related to identification of a segment(s) is evaluated (determined) by also taking into account texts the type of contents, the form, and so forth of which are specified by tags. If it can be determined that the body (bodies or body texts) follows a predetermined style (format) of tags defined in the header or the like, tag analysis may be performed on the basis of the style. To the contrary, even if there is an error in description of a tag name, the tag correspondence relationship (e.g. no end tag) thereof, or the like, correct description of the tags may be estimated by determining/detecting the error.

In a text analysis process, lexical analysis of texts is performed. If the document to be analyzed is a structured document, style specifications or the like, such as tags, are excluded. If linefeed, inter-line spacing, and so forth are described in a markup language, such as tags, lexical analysis may be performed with these replaced with newline characters (treating these as linefeed). In lexical analysis, for example, features of titles (suitability conditions as a title description) different from those of bodies are detected and evaluated. Examples of the features are as follows: a chapter number and/or a section number or the like are given at the head of a paragraph (e.g. a number indicated by N1 in FIG. 3A); an indent or a space character is put at the head (e.g. indentations indicated by I1, I2, I3, I11, I12, and I21 in FIG. 3A); and linefeed is performed after the number of characters that is smaller than that of a body (e.g. title character strings indicated by F1, F2, F3, F11, F12, F21, F22 and F31 in FIG. 3A). Furthermore, about each part (character string) that satisfies some or all of the above conditions, likelihood conditions as a title are evaluated. Examples of the conditions are as follows: no period, colon, semicolon or square bracket (or quotation mark) is provided at the end; the end is not a declinable word in the case of Japanese; and substantive verbs (be, is, are, etc.) are omitted in the case of an English phrase. In addition to these, a degree of likelihood of each title candidate part may be evaluated (determined) by distinguishing the title candidate part(s) from the other part(s), which is a body part(s), detecting characteristic word(s) and/or phrase(s) from the body part, and determining whether or not the title candidate part is an expression of a combination of the characteristic word(s) and/or phrase(s).

For example, points are added (or subtracted) in accordance with the above suability and likelihood conditions, so that a combination of these, namely a total point, a relative index value or the like, is taken as the above-described confidence degree. A part between boundary positions of both ends (from the front of a title to the front of the next title) the confidence degree of which satisfies a predetermined reference may be identified as a segment. If chapter numbers and/or section numbers or the like (letters in alphabetical order, order of the Japanese syllabary (50 characters in a-i-u-e-o order), order of the traditional Japanese syllabary (48 characters in i-ro-ha order), etc. included) are described by input operations, these numbers are not always in accurate order. Hence, arrangement order of numbers may be not strictly considered. For example, even if “1” and “3” are detected at the heads of character strings (paragraphs) identified as chapter titles, it is not always necessary to identify the second chapter therebetween.

In an image analysis process, passage segmentation and title identification are performed by using a document image (display image data of a document). Boundaries of each segment (chapter, section, etc.) of a document and a title of the segment are detected from document image data in accordance with detection conditions (rules) that include: arrangement of an inter-segment space and/or an indentation (e.g. a horizontal-direction distance from the left end on the display face or from the leftmost character); and difference in a font type and/or font size (larger than that of a body(ies)). For example, a title that is located at the head of each chanter or section tends to have a bold font and/or a font size that is larger than that of a body(ies). Furthermore, a title and a sentence following the title tend to be indented. In this embodiment, as shown in FIG. 3B, “Hardware” in a subsection of a section “Product A” is indented by using an indent (here, by an indent attribute “ind” in a text tag t), whereas “Software” in another subsection thereof is indented by using a space. They are the same on an image. Furthermore, a space(s) above and/or below a title may be wider than an ordinary inter-line space (e.g. regions indicated by A1, A2, and A3 in FIG. 3A). Furthermore, a title line is not line-fed, and tends to be shorter than a body. In the image analysis process, agreement/disagreement of these, which are detectable from a document image, with/against the layout conditions or the like is quantitatively obtained as the confidence degree. A block (a part between two boundary positions) the confidence degree of which satisfies a predetermined reference is identified as a segment in a document (passage). For example, points are added (or subtracted) on the basis of whether or not the conditions are each satisfied, and an area the total point or relative index value of which satisfies a reference can be identified as a segment.

That is, in the multiple analysis processes, segments (segment areas) are identified and evaluated (confidence degrees are calculated) on the basis of their respective references, and the final segment is determined (one of the segment areas is selected) on the basis of the confidence degrees. Some references may be used for making evaluations in the multiple analysis processes. Examples thereof include, if a title(s) is set as the break identifying position, the length of each title (the number of characters of each title or a distance from the head to the end of each title), the font type of each title, and the font size of each title. Furthermore, in a structured document in particular, text data of a document and its edit screen do not always have the same layout as display image data that is actually output. Furthermore, in display image data, unless otherwise specified, automatic linefeed may be performed at proper positions in a document (passage) according to the font size(s), margins, an object where the display image data is displayed or output (e.g. a display or a printing medium), and so forth.

In the case shown in FIG. 3A and FIG. 3B, an evaluation reference (standard) used in structure analysis can be determined such that the title character strings F11, F12, F21, F22, and F31 described by being line-fed in texts are lower in likelihood as head positions (boundary positions) of segments than the title character strings F1, F2, and F3 described by tags for titles. In image analysis or the like, a large difference in the likelihood is hardly generated between these cases. Furthermore, an evaluation reference (standard) in structure analysis can be determined such that the title character string F21 indented by a space is lower in the likelihood as head positions of segments than the title character string F11 indented by an indent. In image analysis or the like, a large difference in the likelihood is hardly generated between these cases. If, like the title character strings F22 and F31, indentation itself is not performed, the likelihood could be low in image analysis too.

In the case shown in FIG. 3A and FIG. 3B, logical segments form a nested structure (hierarchical structure) where each of sections, which are large segments, is further divided into subsections, which are small segments. If a “Section” or the like is clearly described in a detected title, what level the title is given to can be determined on the basis of the description. If a section number (symbols or the like included; the same applies hereinafter) and a subsection number of a segment are described next to one another, the level of the segment can be determined on the basis of the numbers (e.g. “1-2”).

If neither a word “Section” or the like nor a section number or the like is clearly described, difference in size between title character strings, difference in size between indentations (indents), or the like may be used for level determination. Furthermore, the title of the first small segment (low level) (in this embodiment, the first subsection of each section) tends to be provided on the next line of a section title (title of a high level) without a body text interposed therebetween. By detecting such a characteristic description part, what level of a segment the title is given to may be determined.

In this case too, taking it into account that the numbers may be inappropriately described by a document creator, it is unnecessary to identify the levels as clearly specified in titles. Furthermore, if subsection numbers are clearly specified in titles to the middle of a section or the like, but thereafter not clearly specified, it may be determined on the basis of sizes of title character strings, sizes of indentations, contents of titles, or the like that titles are given to the same level of segments, namely subsections.

Down to what level segments are identified in the construction analysis may be predetermined, or may be determined in accordance with a construction analysis request from the terminal apparatus 40. That is, in a construction analysis process, for example, only segments of one level (e.g. “section”) may be identified, or segments of multiple levels (e.g. “section” and “subsection”) may be identified, taking the nested structure into account. Even if only segments of “section” are identified, in each analysis process, it may be taken into account that the document to be analyzed has the hierarchical structure.

Next, operation to select, for each segment, a proper segment area from segment areas obtained with the multiple analysis processes will be described. Hereinafter, a case where segments of a single level (“section”) in the abovementioned hierarchical structure are identified on the basis of section titles will be described as an example.

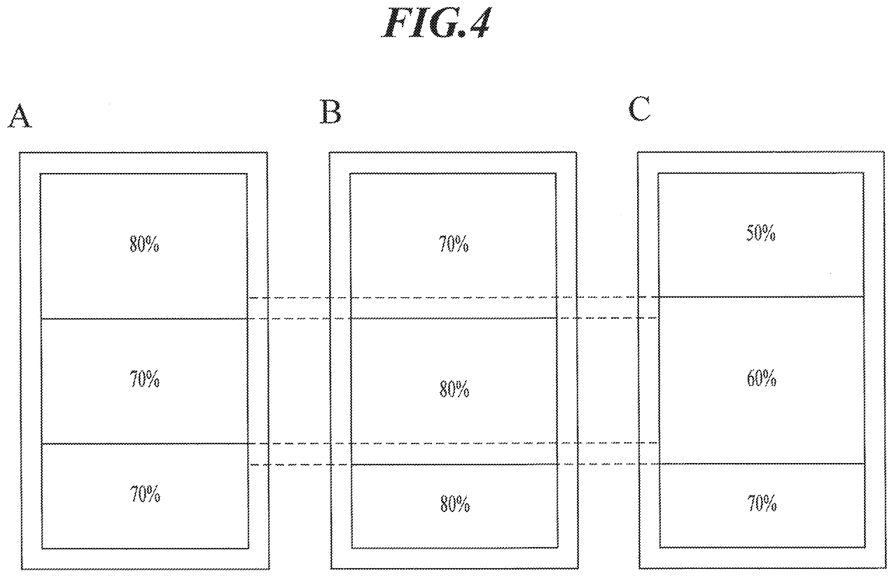

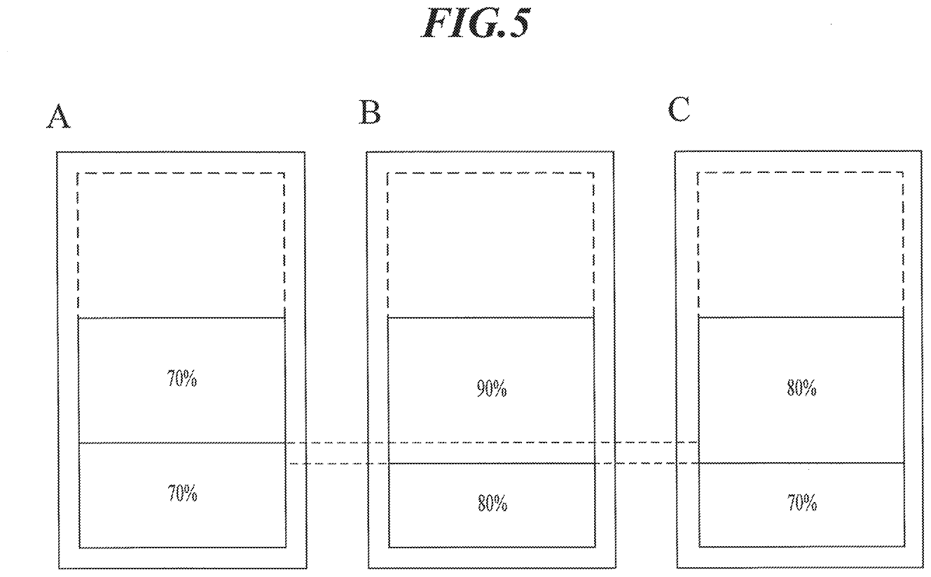

FIG. 4 shows examples of logical segments (segment areas) of a passage identified with the respective analysis techniques (by using a title(s) as the break identifying position) and confidence degrees (at least based on (degrees of) the likelihood of titles) of the segments. As described above, about an analysis area in document data, segment areas identified with the respective analysis techniques are obtained together with their confidence degrees. For example, as shown in A part of FIG. 4, three segments are identified from a one-page document by tag analysis, and confidence degrees of the respective segments, 80%, 70% and 70%, are obtained. Furthermore, as shown in B part of FIG. 4, three segments are identified therefrom by text analysis, and confidence degrees of the respective segments, 70%, 80% and 80%, are obtained. Furthermore, as shown in C part of FIG. 4, three segments are identified therefrom by image analysis, and confidence degrees of the respective segments, 50%, 60% and 70%, are obtained.

Among these, the segment areas of the first (head or top) segment identified by tag analysis and text analysis are the same, but different from the segment area identified by image analysis. The processing apparatus 10 of this embodiment selects and adopts the segment area having the highest confidence degree. If segment areas having the highest confidence degree identified with two or more of the multiple analysis techniques are different from one another, a segment area may be selected from the segment areas, which have been identified with the respective (three or more) analysis techniques, by majority rule or the like. In the case shown in FIG. 4, the segmentation result by tag analysis (which is equal to the segmentation result by text analysis) having the highest confidence degree (80%) is selected and adopted.

Next, on the basis of the selection result about the first segment, an area following the end (end position) of the first segment is set as the next analysis area, and the logical segmentation is repeated. Simply obtaining different selection results (from different analysis results) about respective segments may generate an overlap or a gap between the selected segments identified with different analysis techniques. In order not to generate such an overlap or gap, a positional relationship between segments is adjusted, and segments are re-identified. That is, in this embodiment, the head of the next segment is adjusted to the selected end position, and the construction analysis process proceeds.

FIG. 5 shows examples of segments (segment areas) identified with the respective analysis techniques and confidence degrees of the segments in a part following the selected first segment of the passage. When the end of the first segment in the passage area as an analysis object is fixed as described above, as shown in A part of FIG. 5 the second segment and the third segment identified by tag analysis both have a confidence degree of 70%. Furthermore, as shown in B part of FIG. 5, the second segment and the third segment identified by text analysis have confidence degrees of 90% and 80%, respectively. Furthermore, as shown in C part of FIG. 5, the second segment and the third segment identified by image analysis have confidence degrees of 80% and 70%, respectively. The boundary position between the second segment and the third segment with each of the analysis techniques is not changed from that identified first time shown in FIG. 4. That is, change in the confidence degrees reflects the head position of the (remaining) segments (second segment, to be specific) being fixed.

The change in the confidence degrees is due to reduction (elimination) of uncertainty in determination about the head position of the second segment (i.e. the end of the first segment) by the head position being fixed. Hence, the confidence degrees properly reflect uncertainty in identification of the end of the second segment, and allow the segment area of the second segment to be identified (determined) more accurately.

As a result of comparison of these, as the second segment, the segment area identified by text analysis (shown in B part of FIG. 5), which has the highest confidence degree, is selected. This segment area of the second segment is the same as that identified by image analysis (shown in C part of FIG. 5), but different from that identified by tag analysis (shown in A part of FIG. 5).

When the segment area of the second segment is fixed, the end of the second segment is fixed. Hence, an area following the end of the second segment is set as the next analysis area, und the logical segmentation is repeated. However, this analysis area is not divided anymore in any of the analysis processes. Hence, the whole remaining analysis area is identified as the third segment. Thus, not the segmentation result obtained by one of the analysis processes is selected for the whole document (passage), but a proper analysis result is selected for each segment of the document (passage) independently. Hence, the segment areas of the respective segments may be determined by different analysis results.

In the above, sections as logical segments are identified by taking positions in front of section titles (headings) as boundaries (break identifying position). However, the setting for identifying boundaries of segments (setting for boundaries of segments) is not limited thereto. For example, if, as the break identifying position, a page end of every predetermined number of pages (e.g. every page) is set, and the segmentation based on the setting (segmentation on a set page layout) is performed, in tag analysis and text analysis, the form feed setting is detected. In image analysis, because the end of each page is immediately determined, a text corresponding to the end is identified.

Furthermore, if, as the break identifying position, a line end of every predetermined number of lines is set, and the segmentation based on the setting (segmentation on a set line-unit layout) is performed, for example, in the tag analysis process, the number of lines when displayed is estimated on the basis of a relationship between the standard number of characters to be displayed in each line with each font size and an output font size, presence or absence of a linefeed setting, and so forth in accordance with a predetermined display style. If linefeed in text data is reflected in the output as it is, in the text analysis process, the number of times linefeed is performed (the number of new lines) is simply calculated. In the image analysis process, the end is identified by calculating the number of lines on a display image. In structured document data and text data, if the layout process is not strictly performed, a deviation (difference) may be generated between the data and the actual display image. If the deviation is due to matters that can be estimated, such as line-end processing of punctuation marks and letters written small, it is possible that confidence degrees may be calculated with the deviation estimated. If such deviations are accumulated, and making evaluations are difficult, or the estimation itself is difficult, evaluations may be calculated, for example, by setting, other than the confidence degrees, degrees of reliability (reliability degrees) of the analysis techniques themselves on the basis of a relationship between document types and the analysis techniques, and so forth, and multiplying the confidence degrees by the corresponding reliability degrees. To deal with the abovementioned layout problems, the reliability degree of image analysis should be set to be higher than the reliability degrees of tag analysis and text analysis.

Information on the setting for the break identifying position, such as the section title, the page end of a predetermined number of pages, and the line end of a predetermined number of lines, is stored in advance in the storage 13 as the abovementioned break identifying position information 132. The break identifying position information may be obtained from the terminal apparatus 40 together with document data and a construction analysis request, and temporarily stored in the RAM 112 (which is, in this embodiment, a part of a storage that stores the break identifying position information together with the storage 13). The controller 11 identifies segments (identifies boundaries of segments) on the basis of the break identifying position information. If the break identifying position information is stored in both the storage 13 and the RAM 112, one of them may have priority over the other. For example, the one stored in the RAM 112 has priority over the one stored in the storage 13, and the setting in the break identifying position information 132 is used with a reference being made thereto if no setting is stored in the RAM 112.

The setting for the break identifying position may not be fixed in advance. For example, in the passage construction analysis, after identifying the hierarchical structure (nested structure), the controller 11 may dynamically determine something related to a predetermined level in the nested structure, for example, determine positions in front of titles of segments of the highest level, as the break identifying position.

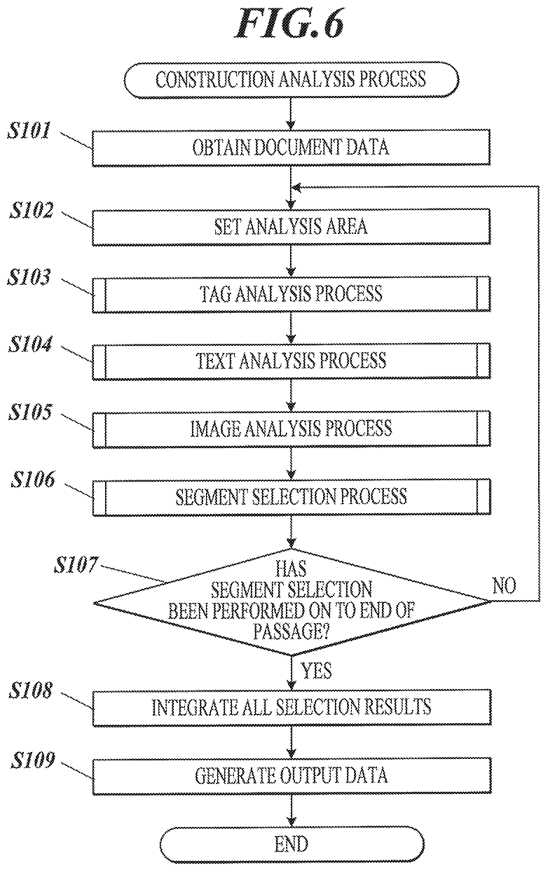

FIG. 6 is a flowchart showing a control procedure by the controller 11 in the construction analysis process.

This construction analysis process is started in response to a construction analysis request sent from the terminal apparatus 40 together with document data.

When the construction analysis process is started, the controller 11 (CPU 111) receives and obtains the document data (Step S101). The controller 11 sets an analysis area in which the construction of a passage is analyzed (Step S102).

The controller 11 performs the tag analysis process on the document data (Step S103). The controller 11 performs the text analysis process on the document data (Step S104). The controller 11 performs the image analysis process on the document data (Step S105). The order of Steps S103 to S105 may be changed as desired.

Alternatively, Steps S103 to S105 may be performed in parallel.

The controller 11 performs a segment selection process (Step S106). The controller 11 determines whether or not segment selection has been performed on to the end of the passage of the document data (Step S107). If the controller 11 determines that segment selection has not been performed onto the end of the passage yet (Step S107; NO), the controller 11 returns to Step S102.

If the controller 11 determines that segment selection has been performed on to the end of the passage (Step S107; YES), the controller 11 integrates all the selection results (Step S108). Here, the controller 11 simply puts the selected segments (segment areas) in order. The controller 11 generates output data on the basis of the selection results (Step S109). The format of the output data may be predetermined, or may be specified by the terminal apparatus 40 when the construction analysis is requested thereby. Here, the controller 11 generates the output data in which titles of chapters, sections, subsections and so forth are enumerated, optionally with numbers. The output data may contain, for example, page numbers and/or line numbers based on display image data. The controller 11 then ends the construction analysis process.

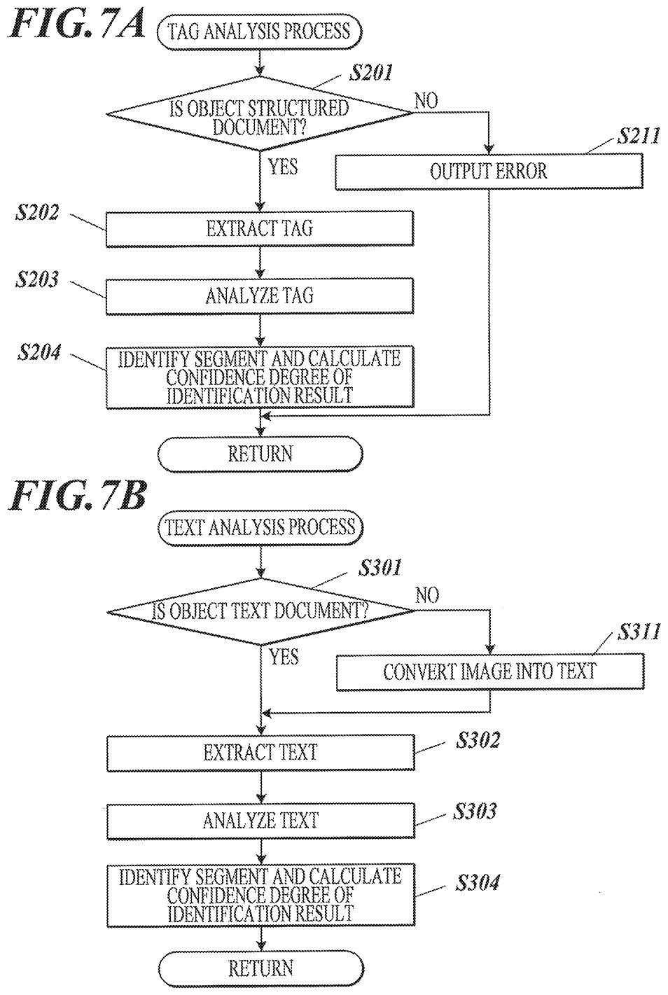

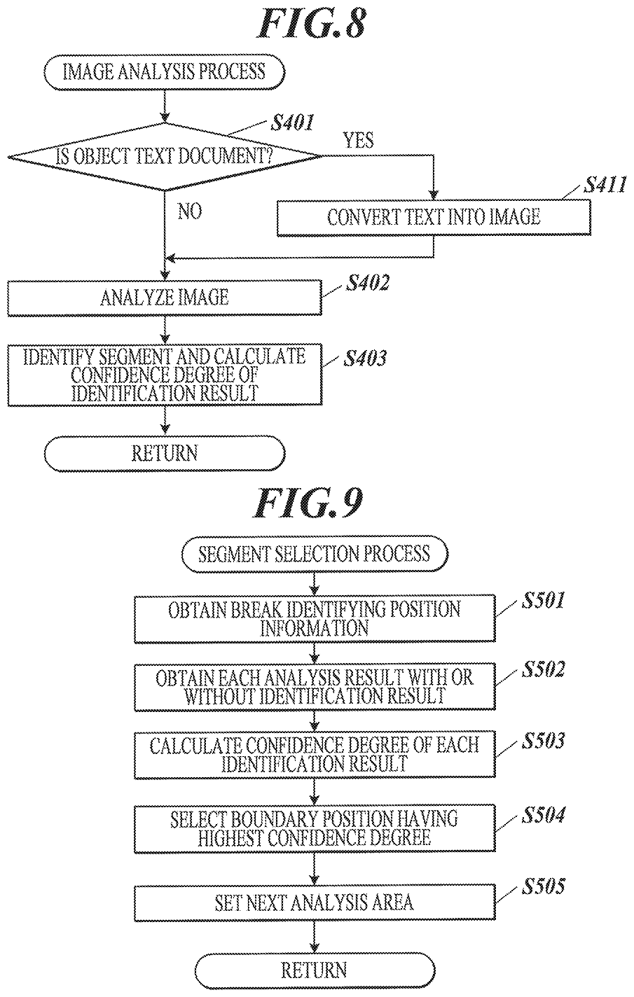

FIG. 7A, FIG. 7B, and FIG. 8 are flowcharts showing control procedures in the tag analysis process, the text analysis process, and the image analysis process called in the construction analysis process, respectively.

When the tag analysis process is called, as shown in FIG. 7A, the controller 11 determines whether or not the document data to be analyzed is (data of) a structured document (described in a markup language) (Step S201). If the controller 11 determines that the document data is not a structured document (Step S201; NO), the controller 11 outputs an error (Step S211), ends the tag analysis process, and returns to the construction analysis process.

If the controller 11 determines that the document data is a structured document (Step S201; YES), the controller 11 extracts tags (Step S202). Tags in the header part or the like not relevant to the document (passage(s)) may be excluded from the beginning from the list of objects to be extracted. The controller 11 analyzes the tags to identify the construction of the passage (Step S203). The controller 11 identifies the construction (segments) by identifying break positions in the passage on the basis of the break identifying position information (Step S204). As described above, instead of obtaining the break identifying position information, the controller 11 may set the break identifying position on the basis of the structure of the document. Furthermore, the controller 11 calculates confidence degrees of the identification results (Step S204). The action(s) in Step S204 may be performed in the segment selection process described below. The controller 11 ends the tag analysis process, and returns to the construction analysis process.

When the text analysis process is called to start, as shown in FIG. FIG. 7B, the controller 11 determines whether or not the document data to be analyzed is (data of) a text document (text data of a structured document included) (Step S301). If the controller 11 determines that the document data is not a text document, namely, is display image data of the document (Step S301; NO), the controller 11 converts the display image data into texts by reading characters from the display image data (Step S311). The controller 11 then proceeds to Step S302. If the controller 11 determines that the document data is a text document (Step S301; YES), the controller 11 proceeds to Step S302.

In Step S302, the controller 11 extracts texts from the document data (Step S302). That is, the controller 11 removes tags of a structured document and objects (e.g. inserted images) except texts of a text document. The controller 11 analyzes the text parts (Step S303). The controller 11 identifies the construction (segments) by identifying break positions in the passage on the basis of the break identifying position information (Step S304). Instead of obtaining the break identifying position information, the controller 11 may set the break identifying position on the basis of the structure of the document. Furthermore, the controller 11 calculates confidence degrees or the identification results (Step S304). The action(s) in Step S304 may be performed in the segment selection process described below. The controller 11 ends the text analysis process, and returns to the construction analysis process.

When the image analysis process is called to start, as shown in FIG. 8, the controller 11 determines whether or not the document data to be analyzed is (data of) a text document (Step S401). If the controller 11 determines that the document data is a text document (Step S401; YES), the controller 11 converts the text document data into an image(s) by generating display image data of the document data (Step S411). The controller 11 then proceeds to Step S402. If the controller 11 determines that the document data is not a text document, namely, is display image data of the document (Step S401; NO), the controller 11 proceeds to Step S402.

In Step S402, the controller 11 analyzes the document image (Step S402). The controller 11 identities the construction (segments) by identifying break positions in the passage on the basis of the break identifying position information (Step S403). Instead of obtaining the break identifying position information, the controller 11 may set the break identifying position on the basis of the structure of the document. At the time, as needed, the controller 11 may extract texts (character strings) from the display image data to be associated with the results of the other analysis processes by identifying break positions (boundary positions). Furthermore, the controller 11 calculates confidence degrees of the identification results (Step S403). The action(s) in Step S403 may be performed in the segment selection process described below. The controller 11 ends the image analysis process, and returns to the construction analysis process.

FIG. 9 is a flowchart showing a control procedure by the controller 11 in the segment selection process called in the construction analysis process.

When the segment selection process is called to start, the controller 11 reads and obtains the break identifying position information 132 from the storage 13 (Step S501). If the break identifying position information is stored in the RAM 112, the controller 11 reads the break identifying position information from the RAM 112. The controller 11 obtains the analysis results (and the identification results of segments (segment areas) if identified) obtained with the respective analysis techniques (Step S502). About each of the analysis results with/without the identification results, the controller 11 does not need to obtain the whole, but may obtain an area thereof definitely containing the head of the analysis area to a boundary position(s) based on the break identifying position information. For example, in segments forming the hierarchal structure, the controller 11 may obtain an area containing one segment of a level that is one rank higher than the level as an identification object or of the highest level.

The controller 11 calculates confidence degrees of the segments (segment areas) identified with the respective analysis techniques. Here, for example, the controller 11 calculates title likelihood of a title(s) and body likelihood of a body(ies) in each segment (segment area) identified by each of the analysis processes, and adjusts, therewith, the confidence degree of each segment (segment area) obtained by each of the analysis processes (Step S503). If the final confidence degrees are all obtained by the analysis processes, it is unnecessary to newly calculate confidence degrees here. Contrary to this, it is possible to calculate confidence degrees here by, in the analysis processes, not calculating confidence degrees but simply identifying parts that could be boundary positions of segments. Furthermore, if Step S204 of the tag analysis process, Step S304 of the text analysis process, and Step S403 of the image analysis process are omitted, the actions therein may all be performed in Step S503.

The controller 11 selects, from the segments (segment areas) identified first in the analysis area by the respective analysis processes, the segment (segment area) having the highest confidence degree, thereby determining the boundary position of the end of the segment (Step S504). The controller 11 sets the boundary position of the end of the segment as the head of the next analysis area (Step S505). The controller 11 ends the segment selection process, and returns to the construction analysis process.

### [First Modification]

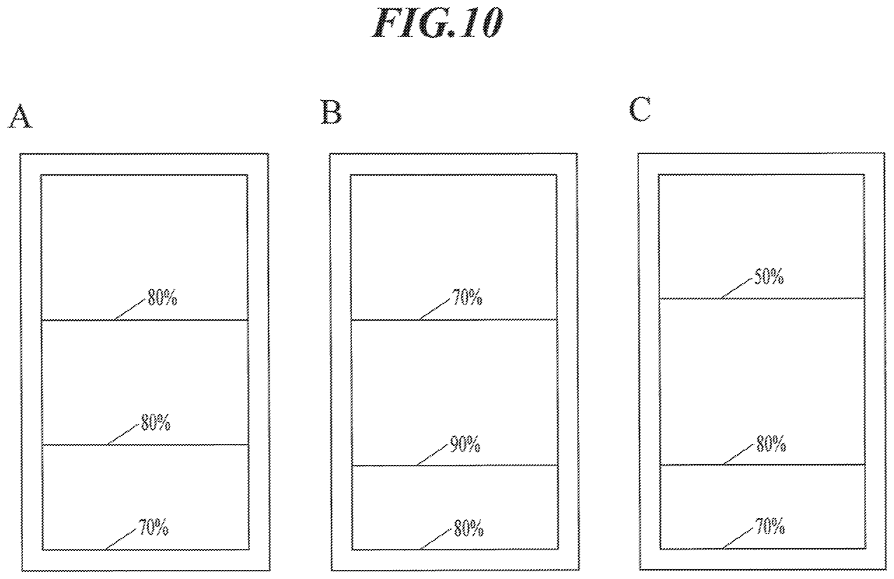

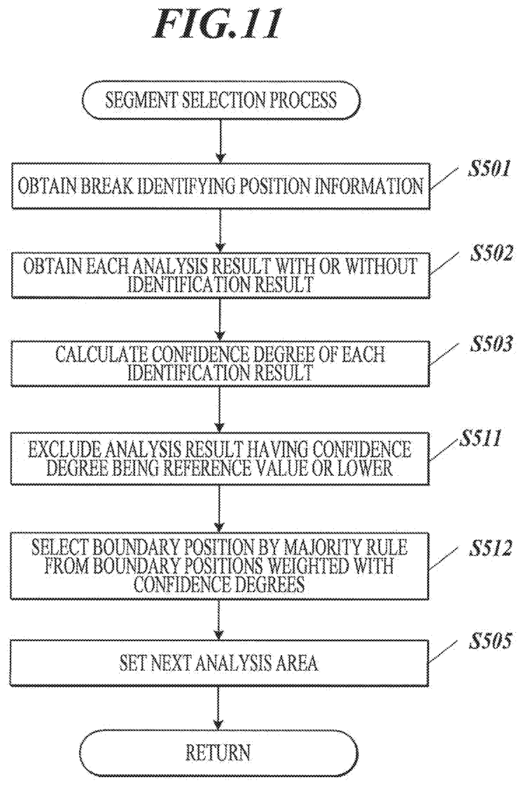

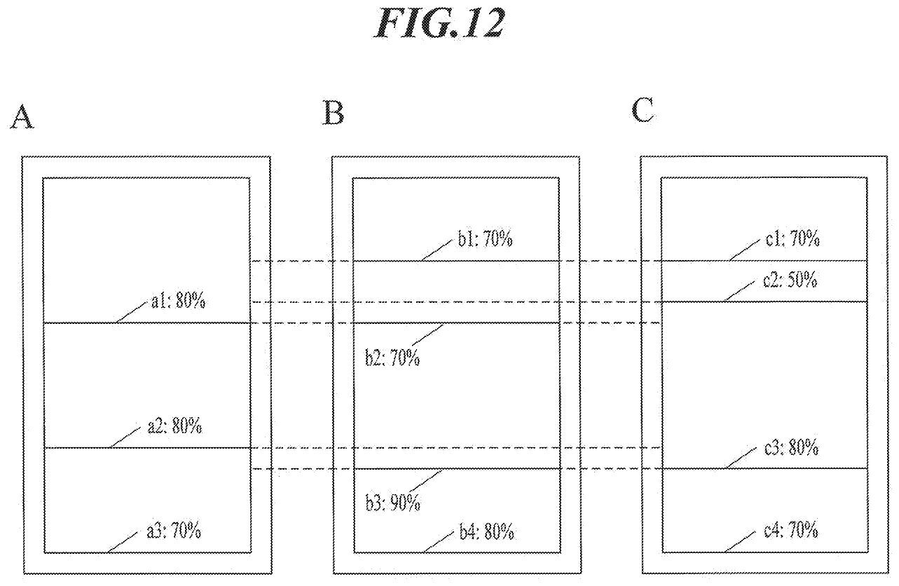

FIG. 10 shows a modification of an object to which the confidence degree(s) is set (first modification). In the first embodiment, the confidence degree as a segment is set as shown in FIG. 4, but in the first modification, the confidence degree is set to the boundary position (break position) of each of (between) the segments (segment areas) identified with the above three types of analysis techniques. As described above, the confidence degree as a segment change according to the combination of the likelihood of the boundary position of the head of the segment and the likelihood of the boundary position of the end of the segment. Determining confidence degrees of boundary positions themselves makes comparison of the boundary positions easy if the boundary positions are determined (selected) in order from the head/top as described above.

### [Second Modification]

FIG. 11 is a flowchart showing a modification of the segment selection process performed by the processing apparatus 10 of the first embodiment (second modification). The segment selection process in the second modification is the same as that in the first embodiment except that Step S504 in the first embodiment is replaced with Steps S511 and S512. As with the first modification, the object to which the confidence degree(s) is set is boundary positions. The action contents same as those in the first embodiment are provided with the same step numbers, and detailed descriptions thereof are not repeated here.

After Step S503, the controller 11 excludes the analysis result(s) having the calculated confidence degree (of the segment area of the first segment) being equal to or lower than a predetermined reference value (Step S511). The controller 11 selects, by majority rule, a boundary position from the boundary positions of the remaining analysis results, the boundary positions being weighted with their respective confidence degrees (Step S512). That is, if one of the three analysis results is excluded, between the remaining two analysis results, one (boundary position) having a higher confidence degree (i.e. one having the highest confidence degree) is chosen, whereas if none of the three analysis results is excluded, and one (boundary position) having the highest confidence degree is different from the boundary position shared by the other two analysis results, the shared boundary position may be selected. The weights may simply be the same. The controller 11 then proceeds to Step S505.

FIG. 12 shows an example of a case when the number of identified segments (segment areas) differs from analysis technique to analysis technique. The numbers of segments identified in an analysis area with the respective analysis techniques could be different from one another.

For example, if, before the boundary position closest to the head of an analysis area (boundary position a1 shown in A part of FIG. 12) (or in one segment (the segment area of one unit segment, which may include the segment area of a segment including a boundary position assumed to correspond to the boundary position of the (identified) segment area)) identified with one analysis technique (one technique), at least one boundary position (boundary position b1 shown in B part of FIG. 12 or boundary positions c1 and c2 shown in C part of FIG. 12) is identified (or two or more segments are identified in the one segment) with another analysis technique (another technique), it is possible that the controller 11 determines that the boundary position(s) identified with the other (another) analysis technique is not identified as a boundary position with the one analysis technique (e.g. in Step S511 shown in FIG. 11, the confidence degree of the boundary position is equal to or lower than a predetermined reference value), and performs the selection (Step S512). Furthermore, if all the analysis results are excluded in Step S511, it is possible that the controller 11 selects none of the boundary positions identified as selectable objects (Step S512). That is, about a boundary position of a segment identified with not all but some of the analysis techniques, whether or not to identify the position as a boundary position may be determined. Unless such adjustment is performed, boundary positions a1, b1, and c1 are compared to one another, boundary positions a2, b2, and c2 are compared to one another, and then boundary positions a3, b3, and c3 are compared to one another. That is, boundary positions not corresponding to one another are compared to one another, which could lead to a strange result(s). In addition, there will be no boundary position identified by tag analysis corresponding to boundary positions b4 and c4.

### [Third Modification]

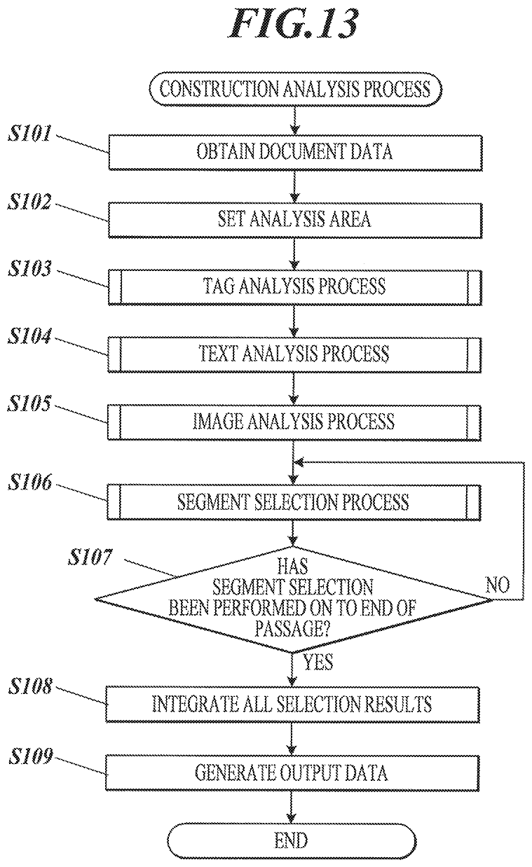

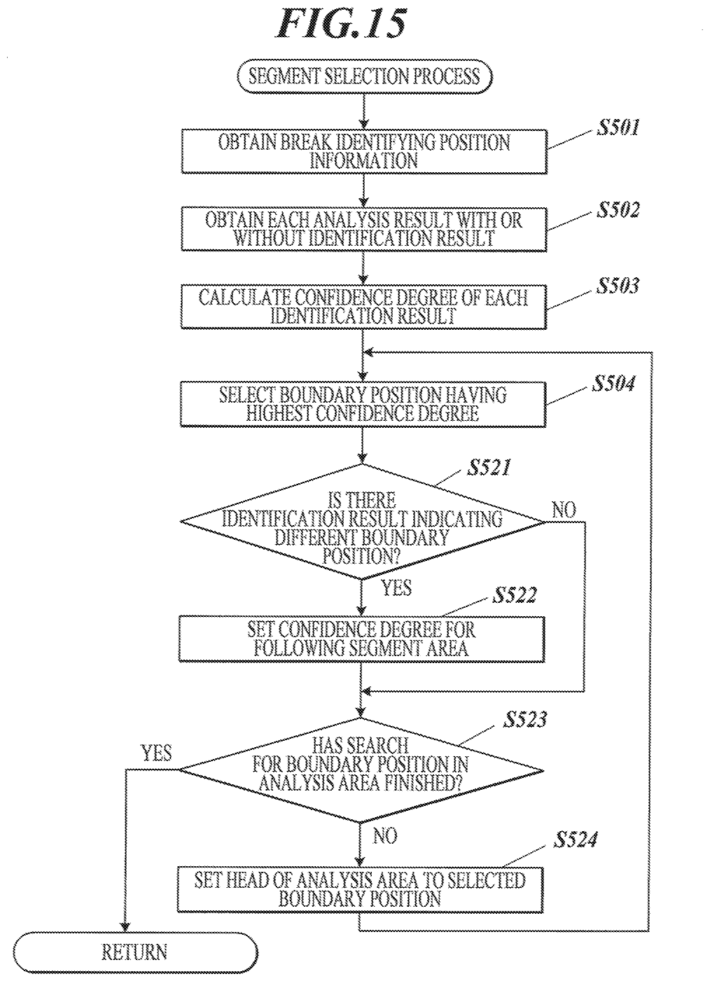

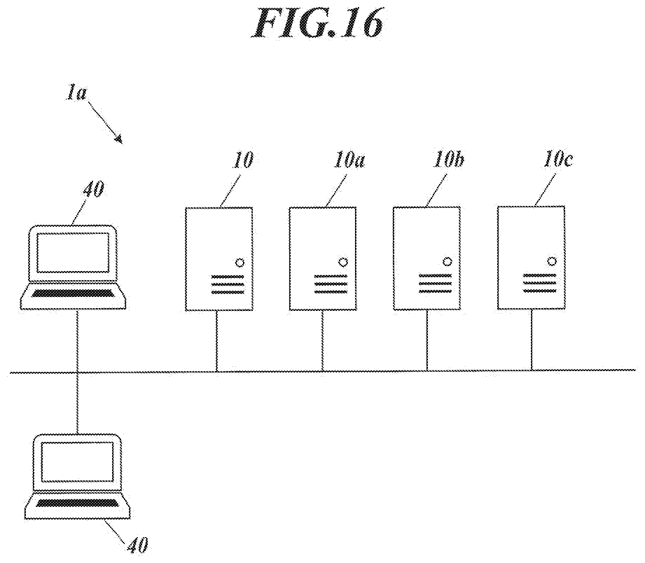

FIG. 13 and FIG. 15 are flowcharts showing a modification of the construction analysis process performed by the processing apparatus 10 of the first embodiment (third modification) and a control procedure by the controller 11 in the segment selection process called in the construction analysis process according to this modification.

The construction analysis process in the third modification shown in FIG. 13 is the same as that in the first embodiment shown in FIG. 6 except that, in the third modification, the return destination from “NO” in Step S107 is not Step S102 but Step S106. That is, the tag analysis process, the text analysis process, and the image analysis process are each performed on the analysis area one time only.

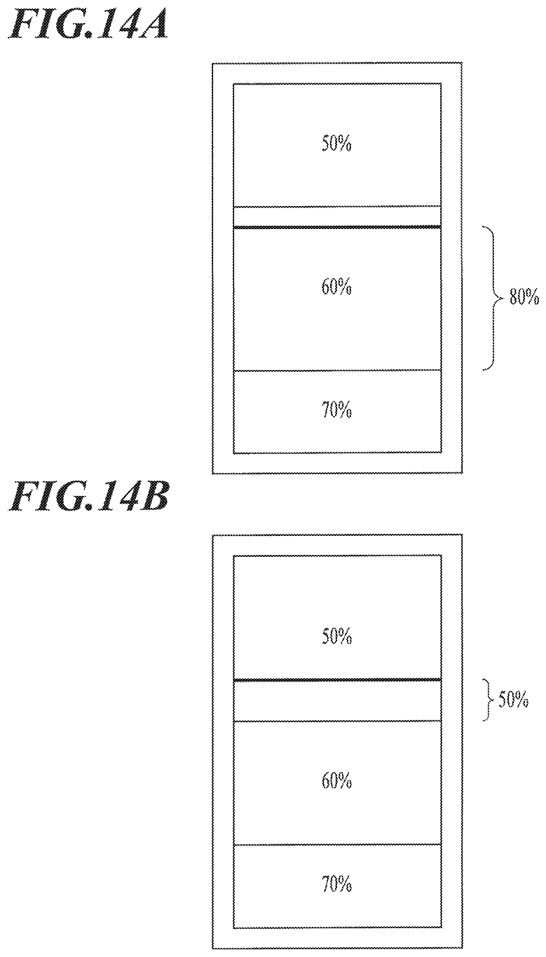

FIG. 14A and FIG. 14B are illustrations to explain boundary position selection and actions for the selection in the segment selection process called to be performed in the construction analysis process according to the third modification.

In the segment selection process of the third modification, starting from the head of the analysis area to the end thereof in order, one of the boundary positions identified with the respective analysis techniques is selected for each segment. If, as shown in FIG. 14A, before the selected boundary position (represented by a bold line), a boundary position identified with an unselected analysis technique is present (if an unselected segment area is different from the selected segment area), about this unselected analysis technique, the segment area of the next segment is reduced. Meanwhile, if, as known in FIG. 14B, after the selected boundary position (represented by a bold line), a boundary position identified with an unselected analysis technique is present (if an unselected segment area is different from the selected segment area in the opposite direction from the above), about this unselected analysis technique, from the (unselected) segment area of the segment, a part following the selected boundary position is separated. A confidence degree is newly set for such a part(s) that is re-identified (the reduced segment area or the separated segment area) after the abovementioned segment area (identification result) is adjusted (the confidence degree of its original segment (segment area) is adjusted) when the segment area is adjusted. The confidence degree may be simply the confidence degree of the segment (segment area) to which the part originally belong, or may take confidence degrees of segments (segment areas) above and/or below the segment (segment area) into account. Alternatively, in a state in which a boundary position of a segment including the part is determined, a confidence degree may be calculated for the segment. In the case shown in FIG. 14A, the confidence degree of the original segment area (of the second segment) is 60%, whereas the confidence degree of the area of the remaining part is 80%. In the case shown in FIG. 14B, the confidence degree of the original segment area (of the first segment) is 50%, whereas the confidence degree of the area of the separated part is also 50%. At this stage, the segment area of the third segment is not affected, and hence the confidence degree thereof remains at 70% in both cases shown in FIG. 14A and FIG. 14B.

FIG. 15 is a flowchart showing a control procedure by the controller 11 in the segment selection process called to be performed in the construction analysis process according to the third modification. The segment selection process in the third modification is the same as that in the first embodiment shown in FIG. 9 except that, in the third modification, Steps S521 to S523 are added, and Step S505 in the first embodiment is replaced with Step S524. The action contents same as those in the first embodiment are provided with the same step numbers, and detailed descriptions thereof are not repeated here.

When the controller 11 selects a boundary position in Step S504, the controller 11 determines whether or not there is an analysis result that identifies a boundary position different from the selected boundary position (Step S521).

If the controller 11 determines that there is an analysis result that identifies a boundary position different from the selected boundary position (Step S521; YES), the controller 11 sets a new confidence degree for each segment area the boundary position of the head of which is changed (Step S522). The controller 11 then proceeds to Step S523. If the controller 11 determines that there is no analysis result that identifies a boundary position different from the selected boundary position (Step S521: NO), the controller 11 proceeds to Step S523.

In Step S523, the controller 11 determines whether or not boundary position search in the analysis area has finished (whether or not all the boundary positions have been treated as selectable objects) (Step S523). If the controller 11 determines that boundary position search in the analysis area has finished (Step S523; YES), the controller 11 ends the segment selection process, and returns to the construction analysis process.

If the controller 11 determines that boundary position search in the analysis area has not finished yet (Step S533; NO), the controller 11 changes and sets the head of the analysis area to the boundary position selected in the most recent Step S504 (Step S524). The controller 11 then returns to Step S504.

As described above, the processing apparatus 10 (document analyzer) of this embodiment includes the controller 11. The controller 11 analyzes the construction of a passage with multiple analysis techniques (in the embodiment, the tag analysis process, the text analysis process, and the image analysis process); for each of predetermined segments (in the embodiment, sections based on section titles) related to the construction of the passage, identifies segment areas with the respective analysis techniques on the basis of the analysis results; and for each of the segments, selects a segment area on the basis of the analysis results from the segment areas identified with the respective analysis techniques.

Using multiple analysis techniques makes it easy to more accurately identify segments according to the type of a document. Furthermore, selecting, for each segment, a segment area obtained with a proper analysis technique reduces incorrect determination of the construction of a passage (or a document), and makes it easy to stably and properly identify a segment area for each segment in a passage that is described inconsistently or in which a describing style changes to another in the middle, in particular, in an unofficial document, an internal document unintended to be disclosed to the public, or the like. Because it is unnecessary to make determination standard/references and/or settings highly complicated or improved on the assumption that a single analysis method is used, time/effort and cost required for processes and maintenance can be reduced. Thus, the processing apparatus 10 can more properly determine the construction of a passage.

This proper determination of the construction of a document makes it possible to effectively extract the title, outline, important terms/words, and so forth from each segment. This helps the user (of the terminal apparatus 40) understand a document or check important points in the document. Furthermore, separating titles from bodies prevents generation of bias and noise, in particular, in extraction of important terms/words (data mining), and enables more accurate processing.

Furthermore, the controller 11 calculates degrees of certainty (confidence degrees) for the respective segment areas identified with the respective analysis techniques, the degrees of certainly being related to the identification results of the segment areas, and selects the segment area on the basis of the degrees of certainty.

Quantitatively evaluating segments (segment areas) identified with the respective analysis techniques and selecting a proper analysis technique for each segment make it possible to easily and more certainly obtain the construction of a passage with accuracy.

Furthermore, for each of the segments, the controller 11 selects the segment area having the highest degree of certainty among the degrees of certainty obtained with the respective analysis techniques. Simply using, for each segment, the segment area identified with an analysis technique that is assumed to identify the segment area most accurately makes it possible to identify the construction of a passage efficiently without complicating processes.

Furthermore, the controller 11 identifies titles related to the respective segment areas, and calculates the degrees of certainty on the basis of degrees of likelihood of the identified titles. In many documents, a title is provided at the head of each logical segment. Determining a degree of properness of a title as the title provided at the head of a logical segment, which is the identification object, makes it possible to divide a passage into logical segments more accurately. A title tends to have multiple features including: a structural feature, namely, clearly being specified by tags; a lexical feature, namely, showing representative words in a logical segment in a short form; and a denotative feature, namely, being described in boldface type, being indented, or being provided with a space(s) above and/or below the title. However, these are not absolute conditions as a title. Hence, detecting these features in parallel, evaluating the features, and selecting one having a high degree of certainly make it possible to determine logical segments more stably and certainly. A body-like denotation/indication may contain, for example, itemized matters and quotations, other than ordinary sentences.

Furthermore, the controller 11 identifies titles and bodies related to the respective segment areas, and calculates the degrees of certainty on the basis of degrees of likelihood of the identified titles and degrees of likelihood of the identified bodies. That is, evaluating not titles only but both titles and bodies in a parallel manner and/or a relative manner makes it possible to determine logical segments more stably and certainly. The “in a parallel manner” means determining whether or not titles (title candidates) are likely to be titles, or determining whether or not bodies (body candidates) are likely to be bodies, whereas the “in a relative manner” means determining whether or not bodies (body candidates) are unlikely to be titles.

Furthermore, in the second modification, as the multiple analysis techniques, three or more types of analysis techniques are used, and for each of the segments, the controller 11 selects the segment area by majority rule from the segment areas identified with the respective analysis techniques. That is, giving more importance to the same identification result obtained with (shared by) two or more analysis techniques maintains accuracy of identification results more properly, in particular, in a case where none of the confidence degrees obtained with the respective analysis techniques is high enough.

Furthermore, the multiple analysis techniques include text analysis. This identifies logical segments on the basis of, for example, difference between expressional features of titles and bodies included in a passage, and hence can identify substantial/actual segments without being influenced by appearance, ignorance or lack of uniformity in format, or the like.

Furthermore, the multiple analysis techniques include image analysis using display image data of a document including the passage. For example, internal documents are often output without the format made strictly uniform but with the appearance made somewhat uniform. In such a case, the above can easily identify segment areas of logical segments as intended by document creators.

Furthermore, if the passage is described as a structured document, the controller 11 analyzes the construction of the passage with the multiple analysis techniques including tag analysis of the passage. In structured documents, titles and bodies (i.e. types) are often clearly specified. Taking this into account, the above can clearly distinguish parts described as titles from the others. Meanwhile, document creators may unintentionally use incorrect tags that look like not strange (i.e. correct or proper). Hence, combining tag analysis with other analysis technique(s) makes it easy to avoid identifying positions of incorrect tags.

Furthermore, the controller 11 adjusts a positional relationship between the segment areas of the respective segments identified with the respective analysis techniques such that no gap or overlap is generated between the selected segment areas of the respective segments, and re-identifies, for each of the segments, segment areas with the respective analysis techniques. If different segment areas are set/identified with different analysis techniques, and a segment area is simply selected for each segment, a gap or an overlap may be generated between the selected segment areas. The controller 11 operates as described above not to cause such a situation, and identifies segment areas and selects one of these. This makes it possible to properly determine a chain of segments, which are continuous, and thereby properly extract necessary information segment by segment and help the user understand the passage.

Furthermore, the controller 11 selects the segment area for the head (first) segment in a passage area of the passage having been analyzed, and if the end position of the head segment, the segment area of which has been selected, is not the end of the passage area, sets an area following the end position as the passage area 10 be analyzed next, and repeats analyzing the construction of the passage.

Thus, segment areas are identified in order from the head, and each time a segment area is determined (for a segment), the determined segment area (segment) is excluded, and the segmentation is performed again with each of the multiple analysis techniques. This makes it possible to determine confidence degree about unfixed parts more properly. Furthermore, a segment area(s) having a boundary position different from that of the determined segment area is not left as it is. This makes it possible to easily and properly identify a chain of segments, which are continuous.

Furthermore, if the segment areas identified with the respective analysis techniques include an unselected segment area that is different from the selected segment area, the controller 11 adjusts the unselected segment area on the basis of the selected segment area. That is, segment areas are adjusted as needed such that, even if segment areas identified with different analysis techniques are selected for respective segments, the selected segment areas (selected segments) do not become discontinuous or overlap with one another. This makes it possible to property identify a chain of segments, which are continuous.

Furthermore, in the third modification, the controller 11 adjusts the degree of certainty of the adjusted segment area. Because a boundary position of the abovementioned different segment area identified with another analysis technique is corrected/adjusted (fixed), only the confidence degree about the other boundary position thereof that is not corrected/adjusted (fixed) needs be calculated. This makes it possible to more properly compare evaluations, and identify segments having a high degree of certainty in order.

Furthermore, as shown in the second modification, if in the segment area of one segment identified with one analysis technique, a plurality of segments is identified with another analysis technique, the controller 11 determines on the basis of the analysis results whether or not to identify the plurality of segments in the segment area of the one segment. That is, if the numbers of segments identified with the respective analysis techniques are different from one another, and there is a part where a boundary position is identified with an analysis technique, but the part does not correspond to some or all of the boundary positions identified with the other analysis techniques, it is first determined whether or not a boundary position is present in the part. This can reduce a possibility to identify boundary positions of unnecessary segments, and also avoid raising a situation where segments (segment areas) identified with multiple analysis techniques but not corresponding to one another are compared to one another.

Furthermore, the processing apparatus 10 includes the storage 13 (RAM 112 maybe included) that stores the break identifying position information 132 as a setting for a boundary of each of the segments, wherein the controller 11 identifies a boundary of each of the segments on the basis of the setting. This makes it possible to divide a passage into segments with desired breaks on the basis of the predetermined break identifying position information 132.

Furthermore, the controller 11 sets the break identifying position, and identifies a boundary of each of the segments on the basin of the setting. For example, if a passage having the hierarchical structure is divided into logical segments, the controller 11 sets a proper level of the logical segments. That is, the processing apparatus 10 can identify segments flexibly according to their use or the like.

Furthermore, the setting for the break identifying position includes a position in from of a title related to each of the segments. This makes it possible to determine a setting to identify segments on the basis of titles, and thereby makes it possible to identify logical segments easily and certainly.

If a passage composed of multiple levels is divided into segments of a low level, the title of a segment of a high level may be included in the first segment of the low level in the segment of the high level, together with the title of the segment of the low level.

Furthermore, the setting for the break identifying position includes a page end of every predetermined number of pages that is one or more if a page layout is set in document data including the analysis area of the passage. Thus, a passage can be divided not only into logical segments in units of chapters or sections, but also can be divided into segments in accordance with a display/output style. That is, the above makes it possible to divide a passage into various types of segments in accordance with a desired course of action, for example, for helping the user understand the passage or for extracting important points.

Furthermore, the setting for the break identifying position includes a line end of every predetermined number of lines that is one or more if a line-unit layout is set in document data including the analysis area of the passage. As with the page end described above, the above makes it possible to divide a passage into various types of segments in accordance with a display/output style, and the final result of the segmentation can be properly used, for example, for helping the user understand the passage.

Furthermore, a document analysis method employed by the processing apparatus 10 of this embodiment includes: analyzing the construction of a passage with multiple analysis techniques: for each of predetermined segments related to the construction of the passage, identifying segment areas with the respective analysis techniques on the basis of the analysis results; and for each of the segments, selecting a segment area on the basis of the analysis results from the segment areas identified with the respective analysis techniques. Analyzing the construction of a passage with this method makes it possible to determine the construction of a passage easily and more accurately, regardless of the type of document, in particular, unofficial documents, which are not always described in a uniform or accurate style.

Furthermore, the programs 131 cause a computer (processing apparatus 10) to analyze the construction of a passage with multiple analysis techniques; for each of predetermined segments related to the construction of the passage, identify segment areas with the respective analysis techniques on the basis of the analysis results; and for each of the segments, select a segment area on the basis of the analysis results from the segment areas identified with the respective analysis techniques. Thus, the programs allow a CPU(s) to perform the above operations by software. This makes it possible to easily perform the processes disclosed herein in a wide range of situations without a special hardware component, and thereby determine the construction of a passage.

### [Second Embodiment]

Next, a passage construction analysis system according to a second embodiment will be described.

FIG. 16 shows overall configuration of a passage construction analysis system 1a according to this embodiment. In the passage construction analysis system 1a of this embodiment, in addition to the processing apparatus 10, processing apparatuses 10a to 10c connect to the network. Furthermore, in the passage construction analysis system 1a, a plurality of terminal apparatuses 40 is connectable. FIG. 16 shows two terminal apparatuses 40.

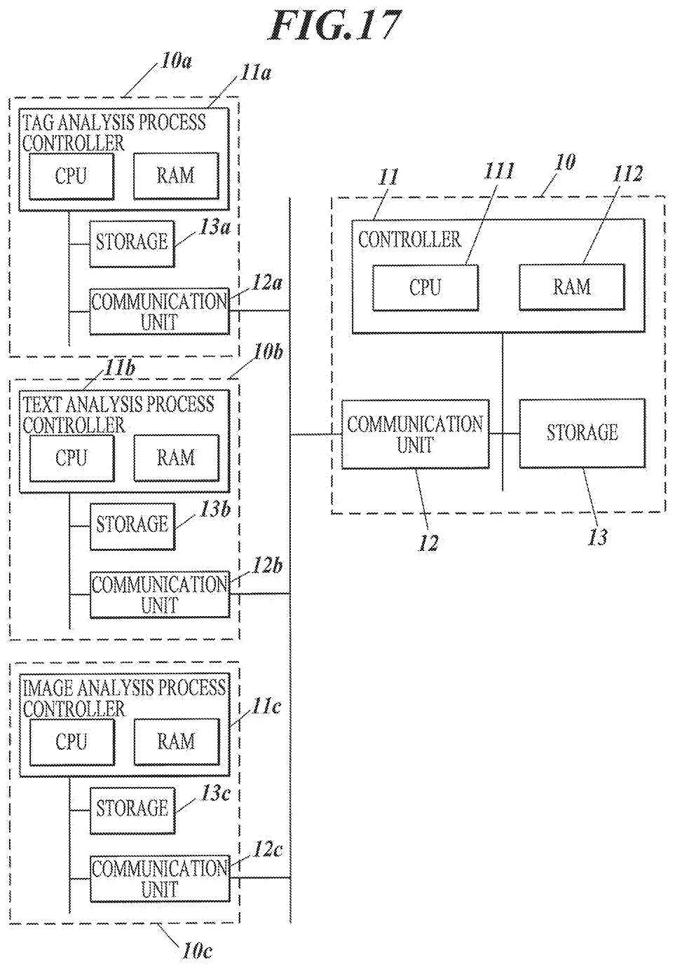

FIG. 17 is a block diagram showing functional configuration of a part of the passage construction analysis system 1a, wherein the part performs the construction analysis process. The processing apparatus 10 and the processing apparatuses 10a to 10c connect to one another by wiring. These processing apparatuses 10, 10a, 10b and 10c are provided, for example, within a LAN, and connect to one another with LAN cables.

The processing apparatuses 10, 10a, 10b and 10c have their respective functions. The processing apparatus 10 integrates the processes of the construction analysis process. The processing apparatus 10a includes a tag analysis process controller 11a, a communication unit 12a, and a storage 13a, and specializes in the tag analysis process with the tag analysis process controller 11a executing a program stored in the storage 13a. The processing apparatus 10b includes a text analysis process controller 11b, a communication unit 12b, and a storage 13b, and specializes in the text analysis process with the text analysis process controller 11b executing a program stored in the storage 13b. The processing apparatus 10c includes an image analysis process controller 11c, a communication unit 12c, and a storage 13c, and specializes in the image analysis process with the image analysis process controller 11c executing a program stored in the storage 13c.

The tag analysis process controller 11a, the text analysis process controller 11b, and the image analysis process controller 11c as individual analyzers (which may be provided in different PCs and operate independently) each include a CPU and a RAM, and each perform the abovementioned process in accordance with the program that defines details of the process. Capability of the CPU and capacity of the RAM may be adjusted to be suitable for the process. Alternatively, a plurality of CPUs and/or a plurality of RAMs may be provided (i.e. at least one CPU and one RAM are provided) in each of the controllers 11a, 11b and 11c to be suitable for the size of the load or the like. Furthermore, the tag analysis process controller 11a, the text analysis process controller 11b, and the image analysis process controller 11c may each include a dedicated hardware component(s) suitable for the process to perform and control, too.

The controller 11 of the processing apparatus 10 sends document data to be analyzed in response to construction analysis requests obtained from the terminal apparatuses 40, to (the communication units 12a to 12c of) the processing apparatuses 10a to 10c via the communication unit 12, and requests the processing apparatuses 10a to 10c to perform their respective processes and send results thereof.

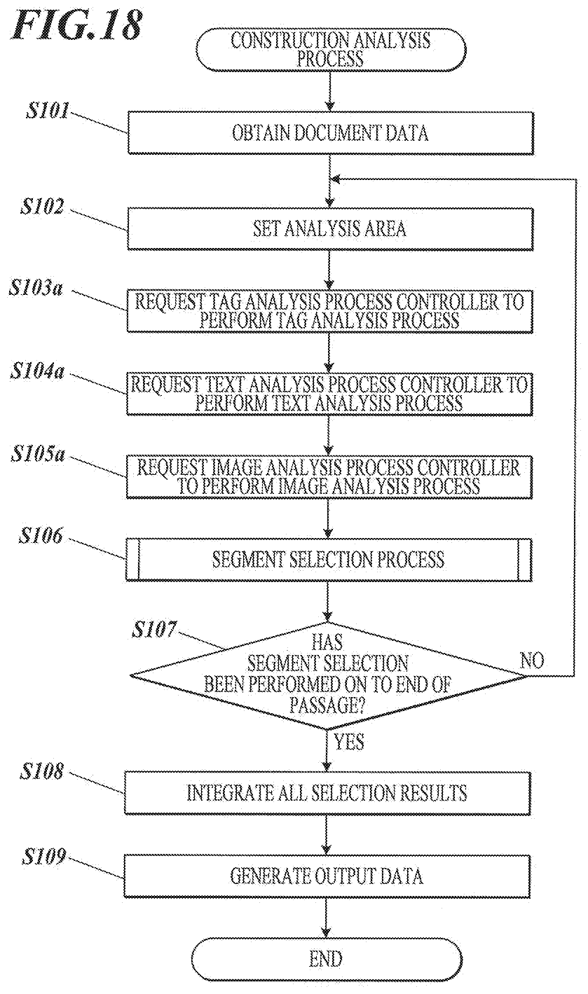

FIG. 18 is a flowchart showing a control procedure by the controller 11 in the construction analysis process performed by the processing apparatus 10 according to the second embodiment. The construction analysis process in the second embodiment is the same as that in the first embodiment except that Steps S103, S104, and S105 in the first embodiment are replaced with Steps S103a, S104a, and S105a, respectively. The action contents same as those in the first embodiment are provided with the same step numbers, and detailed descriptions thereof are not repeated here.

After Step S102, the controller 11 requests the tag analysis process controller 11a of the processing apparatus 10a to perform the tag analysis process (Step S103a). The controller 11 requests the text analysis process controller 11b of the processing apparatus 10b to perform the text analysis process (Step S104a). The controller 11 requests the image analysis process controller 11c of the processing apparatus 10c to perform the image analysis process (Step S105a). When receiving analysis results from the tag analysis process controller 11a, the text analysis process controller 11b, and the image analysis process controller 11c, the controller 11 proceeds to Step S106.

The order of Steps S103a to S105a is arbitrary. Alternatively, Steps S103a to S105a may be performed in parallel. If construction analysis requests about different documents (passages) are made by different terminal apparatuses 40, the processing apparatuses 10a to 10c may process the requests in parallel or one by one (in series). If a particular process, for example, the image analysis process, takes a larger load than the other processes (tag analysis process and text analysis process), the passage construction analysis system 1a may have a plurality of processing apparatuses 10c, which perform the particular process (image analysis process), and assign the construction analysis requests to the processing apparatuses 10c in order for the image analysis process.

As described above, a document analyzer(s) in the passage construction analysis system 1a according to the second embodiment includes at least one tag analysis process controller 11a, at least one text analysis process controller 11b, and at least one image analysis process controller 11c (which may be provided in different processing apparatuses), each of which analyzes the construction of a passage with one of the multiple analysis techniques. That is, controllers for respective types of processes are provided, so that the processes can be performed efficiently. Furthermore, the CPU(s) and the memory(ies) (RAM(s)) can be provided in each controller to be suitable for the details of the process.

### [Third Embodiment]

Next, a passage construction analysis system according to a third embodiment will be described.

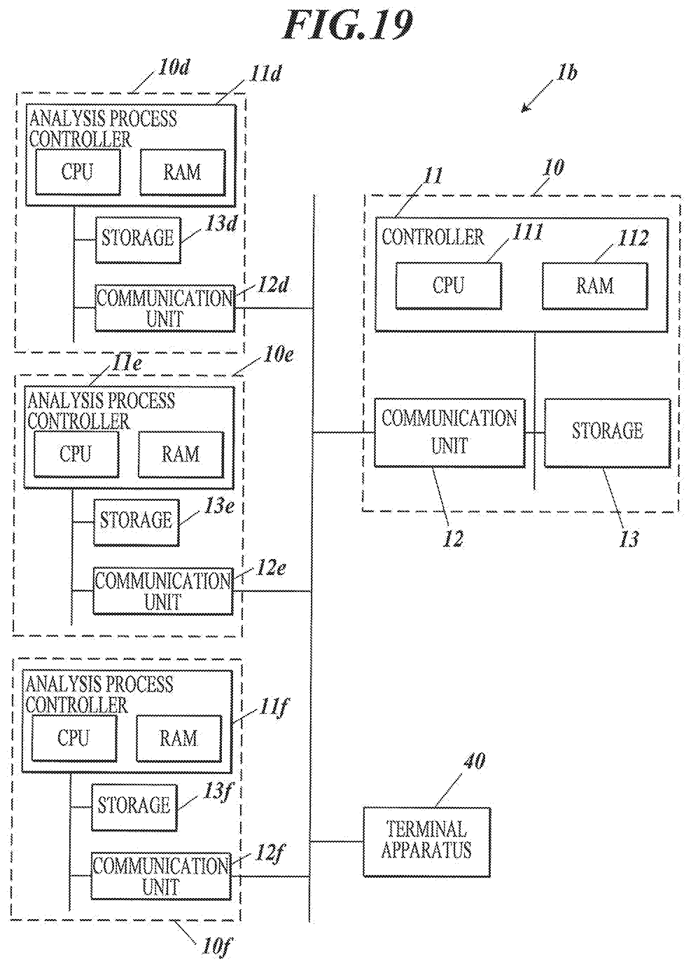

FIG. 19 is a block diagram showing functional configuration of a part of a passage construction analysis system 1b according to the third embodiment, wherein the part performs the construction analysis process. The processing apparatus 10 and two or more (in this embodiment, three) processing apparatuses 10d to 10f connect to one another by wiring. These processing apparatuses 10, 10d, 10e and 10f are provided, for example, within a LAN, and connect to one another with LAN cables.

Configuration of the processing apparatus 10 of the third embodiment is the same as that of the processing apparatus 10 of the first embodiment. Unlike the second embodiment, the three processing apparatuses 10d to 10f can each perform all the analysis processes described above. The processing apparatus 10d includes an analysis process controller 11d, a communication unit 12d, and a storage 13d. The processing apparatus 10e includes an analysis process controller 11e, a communication unit 12e, and a storage 13e. The processing apparatus 10f includes an analysis process controller 11f, a communication unit 12f, and a storage 13f. The analysis process controllers 11d to 11f are each a hardware processor that can perform all the tag analysis process, the text analysis process, and the image analysis process.

The processing apparatus 10 integrates the processes of the construction analysis process. When obtaining a construction analysis request, the processing apparatus 10 assigns the processes for the request to the processing apparatuses 10d to 10f in order starting from one that is currently not performing any process, is expected to finish the currently performing process first, is currently having the smallest load, or the like. The assignment of the processes can be set, for example, such that the tag analysis process, the text analysis process, and the image analysis process are performed in descending order of their required loads.

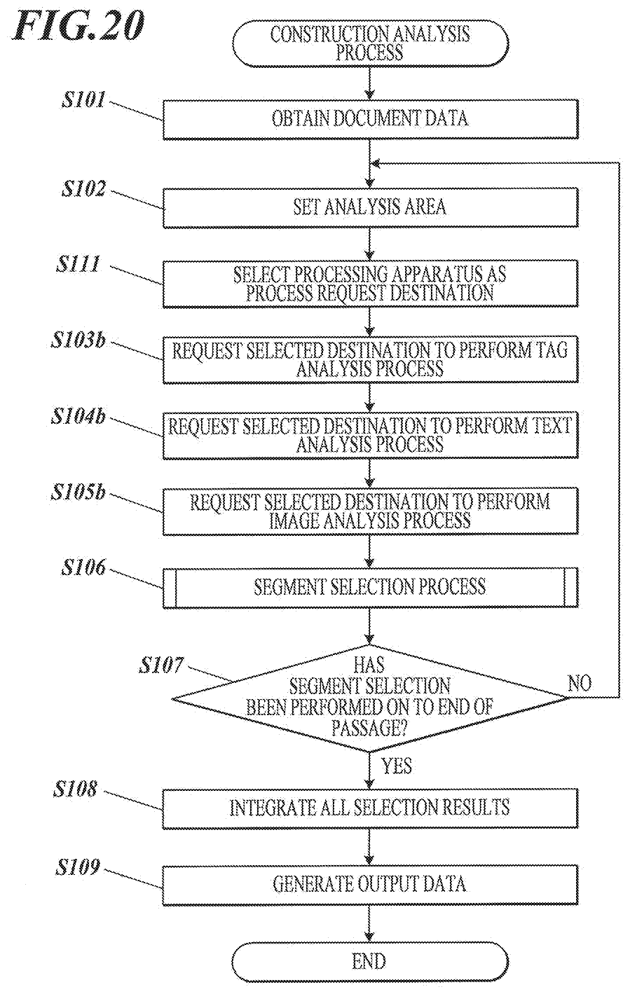

FIG. 20 is a flowchart showing a control procedure by the controller 11 in the construction analysis process performed by the processing apparatus 10 according to the third embodiment. The construction analysis process in the third embodiment is the same as that in the first embodiment except that, in the third embodiment, Step S111 is added after Step S102, and Steps S103, S104, and S105 in the first embodiment are replaced with Steps S103b, S104b, and S105b, respectively. The action contents same as those in the first embodiment are provided with the same step numbers, and detailed descriptions thereof are not repeated here.

After Step S102, the controller 11 sets processing apparatuses as request destinations of the respective analysis processes (Step S111). The controller 11 temporarily stores a request(s) for the processes assigned to the processing apparatuses 10d to 10f and information on this state in the RAM 112 or the like, and determines the request destinations of the tag analysis process, the text analysis process, and the image analysis process on the basis of the information.

The controller 11 requests the processing apparatus set as the request destination of the tag analysis process to perform the tag analysis process (Step S103b). The controller 11 requests the processing apparatus set as the request destination of the text analysis process to perform the text analysis process (Step S104b). The controller 11 requests the processing apparatus set as the request destination of the image analysis process to perform the image analysis process (Step S105b). The order of Steps S103b to S105b is arbitrary. Alternatively, Steps S103b to S105b may be performed in parallel. Furthermore, Steps S103b to S105b may be performed at proper timings according to the progresses of the other processes/actions in the processing apparatuses 10d to 10f.

The controller 11 obtains analysis results from the processing apparatuses, and proceeds to Step S106.

As described above, a document analyzer(s) in the passage construction analysis system 1b according to the third embodiment includes the number of analysis process controllers (11d to 11f) equal to or more than the number of the multiple analysis techniques (in this embodiment, three), and each of the analysis process controllers analyzes the construction of a passage with any of the multiple analysis techniques as assigned. This can disperse the processes according to the loads of the analysis process controllers 11d to 11f, so that the processes can be performed efficiently. In particular, if construction analysis requests about different documents (passages) come in anytime from different terminal apparatuses 40, the processes can be performed efficiently without centralization of the loads required for the processes in one or some processing apparatus(s).

The above embodiments (modifications included) are not limitations but examples, and hence can be variously modified.

For example, in the above embodiments, the processing apparatus 10 (10a to 10f included) identifies all the boundary positions (segment areas or segments). However, if the processing apparatus 10 cannot determine a boundary position or a segment with a sufficient degree of accuracy, the processing apparatus 10 may output a request for manual selection about the part, and identity a boundary position or a segment on the basis of the result of the manual selection. In this case, for example, the processing apparatus 10 sends a display image of an area including the part concerned with a boundary position candidate(s) indicated therein to the terminal apparatus 40, and identifies a boundary position or a segment on the basis of information on a detection result from the terminal apparatus 40, which detects an input operation related to the selection.

Furthermore, in the above embodiments, tag analysis, text analysis and image analysis are used, but other analyses may be included. Furthermore, if in tag analysis, a setting data file other than document data is necessary, the setting data file may be analyzed with a reference being made thereto.

Furthermore, in the above embodiments, logical segments are identified on the basis of titles. In addition to or instead of titles, segmenting lines and/or spaces may be treated as boundaries that divide/cut off the body.

Furthermore, in the above embodiments, only the passage itself is taken into account for the construction analysis, but in image analysis in particular, arrangement, contents, and explanations on headings of embedded images may also be taken into account.

Furthermore, as described above, the construction analysis does not need be performed on the whole document, and the analysis area may be set on a part (passage) of a document only. Furthermore, if the analysis area is long, the analysis area may be gradually slid toward the bottom (end of a document). Alternatively, information on fixed break positions, such as end positions of chapters, may be received and obtained from the terminal apparatus 40 in advance, and logical segments in units of sections may be identified in order of the chapters.

Furthermore, in the above embodiments, segment areas are identified in order from the head of the analysis area. However, this is not a limitation. For example, in the analysis area, segment areas or boundary positions having high confidence degrees may be determined preferentially, and thereafter segment areas or boundary positions between the determined ones may be determined in order. In this case, in particular, on the basis of evaluation results of titles related to the preferentially determined segments (segment areas) or boundary positions, the evaluation reference of confidence degrees related to identification of the other titles may be changed so that evaluation accuracy can be further improved.

Furthermore, in the above embodiments, the controller 11 performs the whole construction analysis process with the CPU 111 by software. Alternatively, a dedicated hardware circuit(s) or the like may partly perform the process.

Furthermore, in the above, as an example of a computer-readable storage medium storing the programs 131 of the processes performed by the controller 11, the storage 13, which includes a flash memory and/or an HDD, is cited. However, the computer-readable storage medium is not limited thereto. As the computer-readable storage medium, a portable storage medium, such as a CD-ROM or a DVD, may be used. Also, as a medium that provides data of the programs disclosed herein via a communication line, a carrier wave may be used.

Furthermore, the specific configurations/components, action contents, control procedures, and so forth disclosed in the above embodiments can be appropriately modified without departing from the scope of the present invention. The scope of the present invention should be interpreted on the basis of the contents described in the claims below.

Although some embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2018-118411 filed on Jun. 22, 2018 is incorporated herein by reference in its entirety.

What is claimed is:

1. A document analyzer comprising a hardware processor that:
analyzes a construction of a passage with multiple techniques, thereby obtaining multiple analysis results;
for each of unit segments related to the construction of the passage, identifies segment areas with the respective techniques based on the analysis results; and
for each of the unit segments, selects a segment area based on the analysis results from the segment areas identified with the respective techniques.

2. The document analyzer according to claim 1, wherein the hardware processor:
calculates degrees of certainly for the respective segment areas identified with the respective techniques, the degrees of certainty being related to identification results of the identification of the segment areas; and
selects the segment area based on the degrees of certainty.

3. The document analyzer according to claim 2, wherein for each of the unit segments, the hardware processor selects the segment area having a highest degree of certainty among the degrees of certainty.

4. The document analyzer according to claim 2, wherein the hardware processor identifies headings related to the respective segment areas, and calculates the degrees of certainty based on degrees of likelihood of the identified headings.

5. The document analyzer according to claim 2, wherein the hardware processor identifies headings and bodies related to the respective segment areas, and calculates the degrees of certainty based on degrees of likelihood of the identified headings and degrees of likelihood of the identified bodies.

6. The document analyzer according to claim 1, wherein
the multiple techniques are three or more types of techniques, and
for each of the unit segments, the hardware processor selects the segment area by majority rule from the segment areas identified with the respective techniques.

7. The document analyzer according to claim 1, wherein the multiple techniques include lexical analysis of the passage.

8. The document analyzer according to claim 1, wherein the multiple techniques include image analysis using display image data of a document including the passage.

9. The document analyzer according to claim 1, wherein if the passage is described as a structured document, the hardware processor analyzes the construction of the passage with the multiple techniques including structure analysis of the passage.

10. The document analyzer according to claim 1, wherein the hardware processor adjusts a positional relationship between the segment areas of the respective unit segments identified with the respective techniques such that no gap or overlap is generated between the selected segment areas of the respective unit segments, and re-identifies, for each of the unit segments, segment areas with the respective techniques.

11. The document analyzer according to claim 10, wherein the hardware processor:
selects the segment area for a head unit segment among the unit segments in a passage area of the passage having been analyzed; and
if an end position of the head unit segment, the segment area of which has been selected, is not an end of the passage area, sets an area following the end position as the passage area to be analyzed next, and repeats analyzing the construction of the passage.

12. The document analyzer according to claim 10, wherein if the segment areas identified with the respective techniques include an undetected segment area that is different from the selected segment area, the hardware processor adjusts, based on the selected segment area, an identification result in which the unselected segment area is identified among identification results of the identification of the segment areas.

13. The document analyzer according to claim 12, wherein the hardware processor:
calculates degrees of certainty for the respective segment areas identified with the respective techniques, the degrees of certainty being related to the identification results;
adjusts, among the degrees of certainty, a degree of certainty of the segment area, the identification result of which has been adjusted; and
selects the segment area based on the degrees of certainty from the segment areas identified with the respective techniques.

14. The document analyzer according to claim 1, wherein if in a segment area of one unit segment among the unit segments identified with one technique among the multiple techniques, a plurality of unit segments is identified with another technique among the multiple techniques, the hardware processor determines based on the analysis results whether or not to identify the plurality of unit segments in the segment area of the one unit segment.

15. The document analyzer according to claim 1 comprising a storage that stores a setting for a boundary of each of the unit segments, wherein
the hardware processor identifies the boundary of each of the unit segments based on the setting.

16. The document analyzer according to claim 1, wherein the hardware processor:
determines a setting for a boundary of each of the unit segments; and
identifies the boundary of each of the unit segments based on the setting.

17. The document analyzer according to claim 15, wherein the setting includes a position in front of a heading related to each of the unit segments.

18. The document analyzer according to claim 15, wherein the setting includes a page end of every predetermined number of pages that is one or more if a page layout is set in document data including the passage.

19. The document analyzer according to claim 15, wherein the setting includes a line end of every predetermined number of lines that is one or more if a line-unit layout is set in document data including the passage.

20. The document analyzer according to claim 1, wherein
the hardware processor includes a plurality of hardware processors,
the hardware processors include at least one hardware processor for each of the multiple techniques, and
the at least one hardware processor analyzes the construction of the passage with one of the multiple techniques.

21. The document analyzer according to claim 1, wherein
the hardware processor includes a number of hardware processors equal to or more than a number of the multiple techniques, and
each of the hardware processors analyzes the construction of the passage with any of the multiple techniques as assigned.

22. A document analysis method comprising:
analyzing a construction of a passage with multiple techniques, thereby obtaining multiple analysis results; for each of unit segments related to the construction of the passage, identifying segment areas with the respective techniques based on the analysis results; and
for each of the unit segments, selecting a segment area based on the analysis results from the segment areas identified with the respective techniques.

23. A non-transitory computer-readable storage medium storing a program to cause a computer to:
analyze a construction of a passage with multiple techniques, thereby obtaining multiple analysis results;
for each of unit segments related to the construction of the passage, identify segment areas with the respective techniques based on the analysis results; and
for each of the unit segments, select a segment area based on the analysis results from the segment areas identified with the respective techniques.
